(19) United States
(12) Patent Application Publication
(10) Pub. No.: US 2026/0128607 A1
(43) Pub. Date: May 7, 2026

(54) SYSTEM AND METHOD FOR CHARGING RECHARGEABLE BATTERIES

(71) Applicant: Christopher McMurry, Phoenix, AZ (US)

(72) Inventor: Christopher McMurry, Phoenix, AZ (US)

(21) Appl. No.: 19/380,791

(22) Filed: Nov. 5, 2025

Related U.S. Application Data
(60) Provisional application No. 63/716,829, filed on Nov. 6, 2024.

(51) Int. Cl. H02J 7/00; F21L 4/00

(52) U.S. Cl. CPC H02J 7/731; H02J 7/50; F21L 4/00

(57) ABSTRACT

A system and method for charging batteries. A charger includes a frame providing a support structure. The frame defines receptacles for receiving the batteries. The charger includes electrical interfaces associated with each of the receptacles configured to electronically connect to contacts of the batteries. A power system for powering the electrical interface to charge the batteries. The charger is configured to be stably stored horizontally or vertically.

### PRIORITY

This application claims the benefit of U.S. Provisional Patent Application No. 63/716,829, filed on Nov. 6, 2024, and entitled “SYSTEM AND METHOD FOR CHARGING RECHARGEABLE BATTERIES”, the entire contents of which are hereby incorporated by reference in their entirety.

### BACKGROUND

### I. Field of the Disclosure

The illustrative embodiments relate to rechargeable lamps and electronics. More specifically, but not exclusively, the illustrative embodiments relate to a rechargeable battery and charging system.

### II. Description of the Art

In recent years electronic lamps and candles have become increasingly popular because of their numerous benefits with regard to environmental, utilization, and safety considerations. For example, rechargeable lamps are used to provide a functional and pleasant aesthetic. These types of lights are particularly used by consumers as well as the restaurant, event, hospitality, cruise, and entertainment industries. Good lighting is important to set the mood and provides the function of allowing individuals to read menus, agendas, paperwork, and so forth. Existing light solutions are useful, but offer limited options for bulk usage, recharging, and distribution.

### SUMMARY OF THE DISCLOSURE

The illustrative embodiments provide a system and method for charging batteries. A charger includes a frame providing a support structure. The frame defines receptacles for receiving the batteries. The charger includes electrical interfaces associated with each of the receptacles configured to electronically connect to contacts of the batteries. A power system for powering the electrical interface charge the batteries. The charger is configured to be stably stored horizontally or vertically.

In other embodiments, the contacts may be aligned utilizing one or more tabs, threads, or fasteners. The batteries may be rounded with an edge that is straight and the contacts may be positioned along the edge. The batteries may be completely rounded, and the contacts may be positioned along the rounded edge. The frame may magnetically align the batteries with the receptacles. The charger may be usable and storable horizontally and vertically with the receptacles supporting the batteries. The charger may include a handle connecting to the frame for a user to hold the charger while adding or removing the batteries. The charger may include an indicator associated with the receptacles including a charging status of each of the batteries. The receptacles may include a first support and a second support associated with a top and a bottom of each of the batteries. The frame may have a flat edge opposite the receptacles to stabilize the charger when positioned horizontally on a surface. The charger may be configured to free stand when positioned vertically on a flat surface. The indicators may utilize colors to indicate the charge status. The charger may include a power system that distributes power to the contacts through wires, traces, or connectors integrated within or connected to the charger. The charger may include a charging port for charging the rechargeable batteries utilizing a standard wall outlet (i.e., 120 V). The charger may include a power adapter configured to plug into the charging port of the charger. The charger may be docked or loaded into a larger storage receptacle.

A method of charging batteries. The batteries are received in a charger. Battery contacts of each of the batteries are electrically interfaced with contacts of the chargers. A charging status of each of the batteries is indicated. The charger is configured to be stably stored horizontally or vertically.

In other embodiments, the charger may be stored horizontally or vertically on flat edges of a frame of the charger. The one or more lights of the charger may indicate a charging status of each of the batteries. The batteries may include a flat edge including the battery contacts. The batteries may include a rounded edge including the battery contacts. The charger may include a handle for a user to carry the charger when adding or removing the batteries. The contacts of the charger may magnetically interface with the battery contacts of each of the batteries. The contacts of the charger may align the contacts of the battery based on a frame shape of the battery, tabs, protrusions/grooves, fasteners, or so forth.

Another illustrative embodiment provides a rechargeable battery. The rechargeable battery includes a frame for storing internal components. The rechargeable battery includes a battery within the frame storing a charge for powering at least a light. The rechargeable battery includes a flattened edge defined within the frame. The rechargeable battery includes contacts integrated with the flattened edge for interface the rechargeable battery with a charger and at least the light. The rechargeable battery includes magnets for aligning the contacts with contacts of the light or charger. The rechargeable battery includes a power button for powering on and off the rechargeable battery.

In other embodiment, the rechargeable battery may be a lithium ion or a solid-state battery. The electronic device may be a light, cordless lamp, appliance, or so forth. The one or more indicators may utilize colors to indicate the charging status of the battery. The one or more indicators may utilize colors to indicate the charging status of the battery. The rechargeable battery may include a user interface for receiving user input and providing information to the user. The rechargeable battery may include an inductive charger configured to charge one or more wireless devices proximate the rechargeable battery.

In one embodiment, the disclosure provides a smart rechargeable battery configured to interface with a cordless lamp or other electronic device. The rechargeable battery includes logic, sensors, and circuitry for monitoring state of charge, temperature, and performance conditions in real time. The rechargeable battery may communicate wirelessly with a charger, mobile device, or other control system to exchange data, receive firmware updates, or propagate configuration settings across multiple devices. The rechargeable battery may further include adaptive charging logic configured to extend battery life and maintain optimal efficiency under varying environmental and operational conditions.

The disclosure also provides a magnetic alignment and charging interface that ensures reliable connection and orientation between the rechargeable battery and the charger or host device. The alignment system may employ permanent magnets, electromagnets, or ferromagnetic materials integrated with each component to secure electrical contacts in a repeatable and self-correcting manner. The charging interface may utilize conductive contact pads, pogo pins, or inductive charging coils to enable wired or wireless charging while minimizing arcing, debris accumulation, or mechanical wear.

In another embodiment, the charger described herein includes logic for managing multiple rechargeable batteries simultaneously. The charger may determine optimal charging parameters for each battery-such as voltage, current, and timing-based on measured temperature, state of charge, and battery age. The charger may utilize artificial intelligence or adaptive algorithms to synchronize charge cycles and maintain consistent performance across a fleet of rechargeable batteries. The charger may also perform software or firmware updates on individual batteries when connected.

The illustrative embodiments further provide enhanced durability and safety features. The rechargeable battery and charger may be hermetically sealed or otherwise protected against environmental exposure using gaskets, coatings, or welded enclosures, achieving water-resistant or waterproof ratings such as IP65 or higher. Built-in safety circuits may prevent over-charging, over-discharging, short-circuiting, or overheating. The components may conform to UL, IEC, or other applicable regulatory standards.

In some embodiments, the rechargeable battery may extend the functionality of the host electronic device beyond simple power delivery. For example, in a cordless lamp application, the battery may include integrated microcontrollers for adjusting brightness, color temperature, flicker rate, or power management based on ambient light, time of day, or user input. The rechargeable battery may also serve as a communication hub, payment processing unit, or network repeater for connected environments, allowing groups of lamps or devices to synchronize wirelessly and operate as an intelligent mesh network.

### BRIEF DESCRIPTION OF THE DRAWINGS

Illustrated embodiments are described in detail below with reference to the attached drawing figures, which are incorporated by reference herein, and where:

FIG. 1 is a pictorial representation of a cordless lamp in accordance with an illustrative embodiment;

FIG. 2 is a pictorial representation of a rechargeable battery in accordance with an illustrative embodiment;

FIG. 3 is a pictorial representation of a bottom portion of the lamp with the rechargeable battery removed in accordance with an illustrative embodiment;

FIG. 4 shows a bottom view of the rechargeable battery within the compartment of the base in accordance with an illustrative embodiment.

FIG. 5 shows a bottom view of the rechargeable battery being removed from the compartment in accordance with an illustrative embodiment;

FIG. 6 is a pictorial representation of a portion of the lamp with the rechargeable battery in accordance with an illustrative embodiment;

FIG. 7 is a pictorial representation of a charger in accordance with an illustrative embodiment;

FIG. 8 is a pictorial representation of a charger utilized for horizontal storage in accordance with an illustrative embodiment;

FIG. 9 is a pictorial representation of the charger of FIG. 8 shown from another side in accordance with an illustrative embodiment.

FIG. 10 is a pictorial representation of a charger utilized for vertical storage in accordance with an illustrative embodiment;

FIG. 11 is a block diagram of a rechargeable battery and charger in accordance with an illustrative embodiment;

FIG. 12 is a pictorial representation of a rechargeable battery environment in accordance with an illustrative embodiment;

FIG. 13 is a flowchart of a process for utilizing a charger in accordance with an illustrative embodiment; and

FIG. 14 is a flowchart of a process for utilizing a rechargeable battery in an electronic device in accordance with an illustrative embodiment.

### DETAILED DESCRIPTION OF THE DISCLOSURE

The illustrative embodiments provide a charger for multiple batteries, an enhanced rechargeable battery, lamp, and charging and storage system. The enhanced rechargeable batteries may also be referred to as rechargeable batteries or smart batteries. In one embodiment, an electronic lamp may be improved with an enhanced rechargeable battery. The rechargeable battery may also be utilized with any number of consumer, commercial, or industrial electronic devices that utilize rechargeable batteries. As a result, the description of a cordless lamp is one example of an electronic device. Other electronic devices that utilize the rechargeable batteries may include appliances (e.g., kitchen, bathroom, business, etc.), lighting systems, electronic decorations, consumer electronics, and so forth.

The enhanced rechargeable battery may be a replacement for the standard battery or batteries provided with the lamp. For example, the standard or default batteries of the lamp may not be configured to be easily removed and charged. The enhanced battery may include a quick release mechanism and may be configured (e.g., design, shape, contacts, etc.) to be utilized with a bulk charging system. Various embodiments of the enhanced rechargeable battery may include additional components and features. The rechargeable battery has a shape that easily fits into the charging system. The rechargeable battery includes contacts that quickly and securely interface with the charging interface of the charging system, such as charging contacts or ports.

The charging system is configured to easily align, receive, electrically interface, charge, and store the rechargeable batteries. The charging system may be utilized to receive and store the rechargeable batteries in a vertical or horizontal position. For example, the charging system may be stable when positioned vertically or horizontally based on the structure of the charging system (e.g., flat edges, handle alignment, etc.). The charging system may include a handle for carrying the charging system in a vertical or horizontal position. The handle may also help stabilize the charging system when horizontally positioned.

The charging system may easily interface with power systems of the applicable country, such as wall outlets or traditional connectors. The charging system may include one or more lights corresponding to the numerous rechargeable batteries that indicate the charging status and potentially other information.

The rechargeable battery may be utilized to convert or retrofit a dumb lamp into a smart lamp. The contacts of the rechargeable battery may provide power to the various components of the cordless lamp as well as control signals. In one embodiment, the lighting component of the cordless lamp is a multi-color light emitting diode. The cordless lamp may utilize one or more different color spectra at a time. As a result, environment specific lighting (e.g., mood lighting) may be implemented. In addition, the flicker controls or flicker rate of the cordless lamp may also be managed. The cordless lamp may also emit specific optical, wireless, or other signals to act as beacons, range extenders, location devices, and so forth. The various settings and configurations of the cordless lamps (including logic and/or software) may be set, configured, modified, and updated in large numbers utilizing the charger and charging system as herein described.

In one embodiment, the cordless lamp may include a receiver or transceiver for communicating with each other, a wireless network, or a wireless device. In one embodiment, the cordless lamp or rechargeable battery may be programmed by a smart phone and corresponding mobile application executed to control, manage, and interact with the cordless lamp and/or rechargeable battery. The cordless lamp, rechargeable battery, or charger may also be controlled from one or more associated remote controls. In another embodiment, the cordless lamp, rechargeable battery, or may interact with control systems, smart systems, or other controllers within the commercial property, residence, venue, event, location, or so forth. For example, home or commercial control systems available through any number of manufacturers (e.g., Apple, Google, Amazon, Honeywell, Samsung, LeGrand, etc.) may be utilized to control the cordless lamp or rechargeable battery. Any number of communications standards, protocols, and/or signals may be utilized to perform communications. In one embodiment, a traditional cordless lamp may be upgraded to work with a remote control by utilizing the rechargeable battery providing an update without changing the circuitry of other portions of the lamp or other appliance.

In one embodiment, a charger or one or more master rechargeable batteries may control a group of other rechargeable batteries associated with the master rechargeable battery. The rechargeable batteries utilized in proximity to each other may form a mesh network utilized to distribute information, data, settings or so forth. For example, settings for a cordless lamp with the rechargeable battery may be propagated to a second cordless lamp, third cordless lamp, and so forth. In one embodiment, only the master cordless lamp or rechargeable battery may include an interface for controlling the settings which may be propagated to any number of other cordless lamps associated with the master cordless lamp.

The rechargeable batteries may also include logic for implementing various settings, parameters, thresholds, preferences, commands, instructions, applications, or so forth. For example, the cordless lamps may have their brightness, color, flicker rate, or other information adjusted wirelessly utilizing a mobile application executed by a communications or computing device or utilizing a charger, docking system, base station, or so forth. The various programs, settings, changes, or updates may be performed in real-time or near real-time.

The cordless lamps, rechargeable batteries, or chargers may also utilize artificial intelligence, adaptive learning, or historical information/settings to adapt to changing circumstances. For example, the rechargeable battery and charger may adapt to changing battery properties to most effectively charge the batteries over time. In another example, in response to determining that the cordless lamps have been manually configured to a particular color and intensity settings at a specified time or based on environmental conditions a number of times, the cordless lamps may automatically make the change at the corresponding time or based on applicable environmental conditions.

The cordless lamps may include any number of decorative bases, covers, shades, or other components. These components may be exchanged as needed to suit the environment, event, conditions, and/or needs of the user. The bases, covers, or frames of the cordless lamps may include any of the functionality of the rechargeable batteries as are herein described. For example, the bases may include the rechargeable battery that interfaces with one or more power components of the cordless lamps. The rechargeable batteries or cordless lamps may include one or more cords (e.g., retractable, connectable, hidden, etc.) for charging different types of devices. The rechargeable batteries may also be utilized for charging wireless devices, such as smart phones or tablets. The rechargeable batteries may include a battery of sufficient size and capacity to charge any number of wireless devices. As a result, customers at a restaurant may be able to charge their smart phones from the cordless lamp while enjoying an evening out.

The cordless lamp and/or rechargeable battery may also include an inductive charger that may charge and power the battery from specialty inductive tables, desks, or other furniture that may be utilized with the rechargeable battery.

In another embodiment, the cordless lamps or rechargeable batteries may include logic and hardware for processing transactions implemented through a card (e.g., credit card, debit card, gift card, etc.), wireless device, wireless communications, or so forth. For example, the cordless lamp may include a port, slot, or reader for credit cards. The cordless lamps or rechargeable batteries may also execute an application for processing transactions associated with the location and/or users of the cordless lamp or rechargeable battery. As a result, the cordless lamp may be able to serve any number of aesthetic and functional purposes.

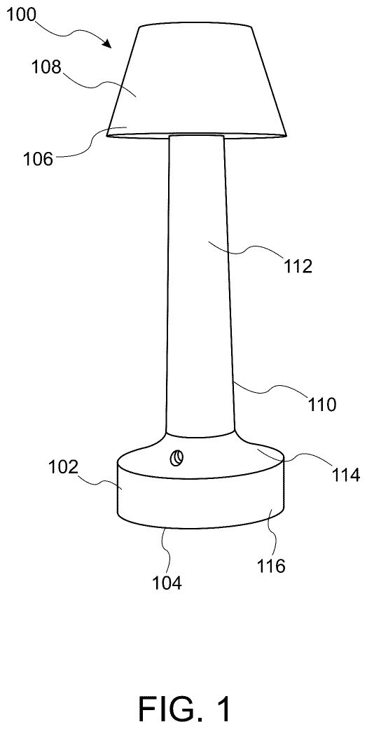

FIG. 1 is a pictorial representation of a cordless lamp 100 in accordance with an illustrative embodiment. The cordless lamp 100 may have various shapes, sizes, configurations, aesthetics, and functionality. In one embodiment, the cordless lamp 100 may include a base 102, a rechargeable battery 104, a bulb 106, a shade 108, and a stem 110. In one embodiment, all or portions of a frame 112 of the cordless lamp 100 may be formed from metal, polymers, or other materials. The various components of the cordless lamp 100 may be integrated or may be connected (e.g., threads, connectors, tabs, releases, etc.).

The embodiments of the cordless lamp 100 and rechargeable battery 104 in FIG. 1 and the other corresponding Figures and description are interchangeable and applicable across all of the Figures and description regardless of restrictions whether natural or artificially contrived. Combinations of the components, features, functions, are expected and suggested herein. The cordless lamp 100 is one example of an appliance that the rechargeable battery 104 may be utilized within.

The illustrative embodiments relate to a cordless lamp 100, rechargeable battery, and charging system for rechargeable batteries. The rechargeable battery 104 may be enhanced with various components and functionality to provide additional features to the cordless lamp 100. The cordless lamp 100 provides illumination without requiring a direct connection to an external power source. The cordless lamp 100 includes several essential components designed to work in harmony to deliver efficient, portable lighting.

The base 102 serves as the foundational support structure for the cordless lamp 100. The base 102 is configured to house various internal components, including the rechargeable battery 104, and provides stability when the cordless lamp 100 is positioned on a surface (e.g., table, counter, stand, support, floor, wall, etc.). In one embodiment, the base 102 may be constructed from durable materials such as metal, plastic, or composite materials, ensuring that the lamp remains securely in place during use. Additionally, the base 102 or the rechargeable battery 104 may feature a non-slip, suction, locking surface, or magnetic bottom surface to prevent unintended movement.

As used herein, the term magnets or magnetic alignment system encompasses any configuration of magnetic or magnetically responsive materials utilized to align and secure the rechargeable battery 104 with a charger or electronic device. The magnetic alignment system may include permanent magnets, electromagnets, or ferromagnetic plates, foils, or coatings integrated with the battery, charger, or both. The system ensures proper orientation of the electrical contacts and stable retention during movement or operation. The strength, polarity, and placement of the magnetic components may be selected to optimize ease of insertion, electrical continuity, and mechanical stability.

As shown, the base 102 may be cylindrically shaped with a top portion 114 that tapers to meet the stem 110. In other embodiments, the base 102 may be square, rectangular cube shape, or may have various other shapes or configurations.

The base 102 also includes an integrated compartment 116 for the rechargeable battery 104. In some embodiments, the base 102 may incorporate a wireless charging coil to enable contactless recharging when placed on a compatible charging dock. The base 102 may also have a charging port for charging the rechargeable battery 104 without removing the rechargeable battery 104 from the compartment 116 of the base 102. The rechargeable battery 104 or the compartment 116 may incorporate a quick release for quickly and efficiently removing the rechargeable battery 104 from the cordless lamp 100. This is particularly important as the cordless lamp 100 may be utilized in an environment where there are numerous cordless lamps that must be positioned, moved, retrieved, recharged, claimed, and other ways maintained for restaurants, hotels, event centers, cruise ships, and other small to large size gatherings, events, facilities, or locations.

The rechargeable battery 104 provides the primary source of electrical power for the cordless lamp 100. In one embodiment, the battery 104 is a rechargeable lithium-ion battery, solid-state battery, ultra-capacitor, or other battery or power storage device chosen for its high energy density, long cycle life, and ability to provide consistent power output over extended periods. The rechargeable battery 104 is housed within the base 102 and is electrically connected to the bulb 106 via an internal circuit.

The capacity of the rechargeable battery 104 may vary based on the size of the cordless lamp 100 and intended usage. For instance, larger models may be equipped with higher-capacity batteries to allow for longer usage times between charges. In some embodiments, the rechargeable battery 104 may include safety features such as overcharge protection, short-circuit protection, and temperature control to ensure safe operation.

The bulb 106 is the primary light-emitting component of the cordless lamp. In a preferred embodiment, the bulb 106 is an LED (light-emitting diode) due to its energy efficiency, low power consumption, and long lifespan. The LED bulb 106 is powered by the rechargeable battery 104 and is mounted at the top of the stem 110 to provide direct or diffused illumination depending on the design of the cordless lamp 100.

The bulb 106 may include additional features such as dimming capability, color temperature adjustment, or preset lighting modes, which may be controlled via a switch or control interface located on the base 102 or remotely. For example, the cordless lamp 100 may include a transceiver for receiving control signals remotely from a remote control, wireless connection (e.g., infrared, Bluetooth, Wi-Fi, Zigbee, etc.), cell phone, tablet, controller, or so forth. In some embodiments, the bulb 106 may be replaceable to allow for customization or future upgrades to the cordless lamp 100.

The shade 108 is positioned over the bulb 106 and serves to diffuse the emitted light, reducing glare and creating a more uniform distribution of light. In one embodiment, all or portions of the shade 108 may be constructed from or include metal, fabric, frosted glass, plastic, or other translucent materials, depending on the aesthetic and functional requirements of the cordless lamp 100. Different lamps or lights may have different light emission patterns and requirements.

The shape of the shade 108 may vary. For example, the shade 108 may be conical, cylindrical, pyramid-shaped, rectangular-shaped, or dome-shaped to suit the intended style and purpose of the lamp. The shade 108 may be detachable or permanently affixed to the cordless lamp 100, depending on the design. Additionally, the shade 108 may be configured to enhance the light distribution by redirecting light or focusing the light on a specific area.

In one embodiment, the shade 108 may include a solar cell or may be formed from materials with a solar charging capacity. As a result, the shade 108 may recharge the rechargeable battery 104 when sunlight or artificial light is available.

The stem 110 provides structural support, connecting the base 102 to the bulb 106 and shade 108. The stem 110 may be constructed from metal, plastic, or other sturdy materials capable of supporting the weight of the bulb 106 and shade 108. In some embodiments, the stem 110 may be fixed in position, while in others, it may be adjustable to allow for the direction of the light, aesthetics of the cordless lamp 100, or general appearance, to be altered.

In one embodiment, the stem 110 may include an integrated hinge, pivot, or flexible neck, allowing users to reposition the bulb 106 and shade 108 to achieve the desired lighting angle. Additionally, the stem 110 may contain internal wiring to deliver power from the battery 104 to the bulb 106, ensuring a clean and streamlined appearance. The components of the cordless lamp work in concert to provide a functional and aesthetically pleasing cordless lamp 100 suitable for use in a variety of settings, including homes, offices, and outdoor environments.

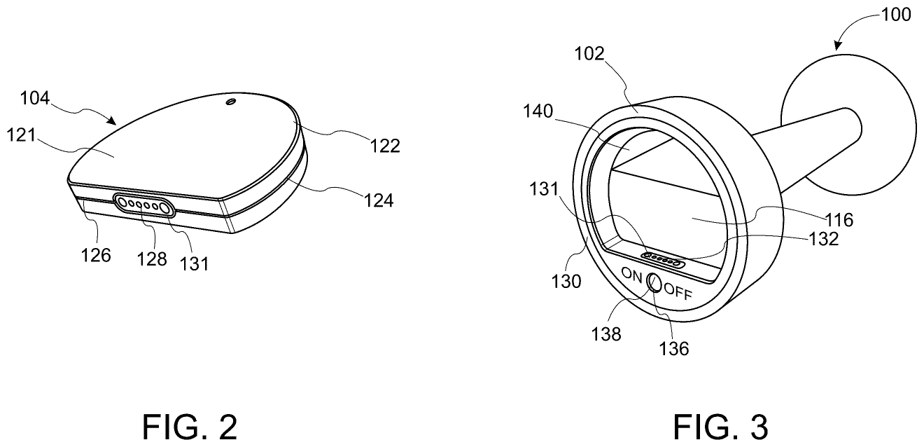

FIG. 2 is a pictorial representation of a rechargeable battery 104 in accordance with an illustrative embodiment. The rechargeable battery 104 may utilize various shapes or configurations. In one embodiment, the rechargeable battery 104 may include a body 122, a curved edge 124, a flat edge 126, contacts 128, and magnets 131.

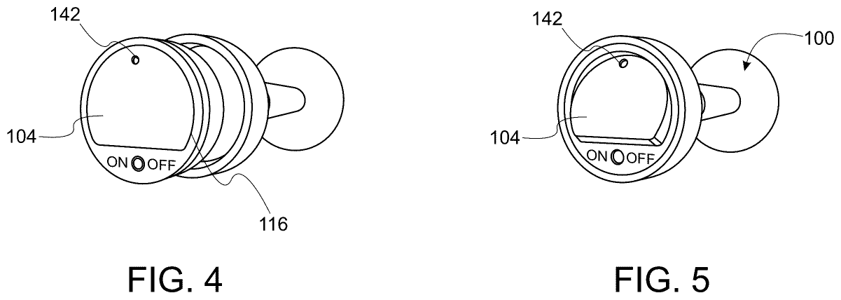

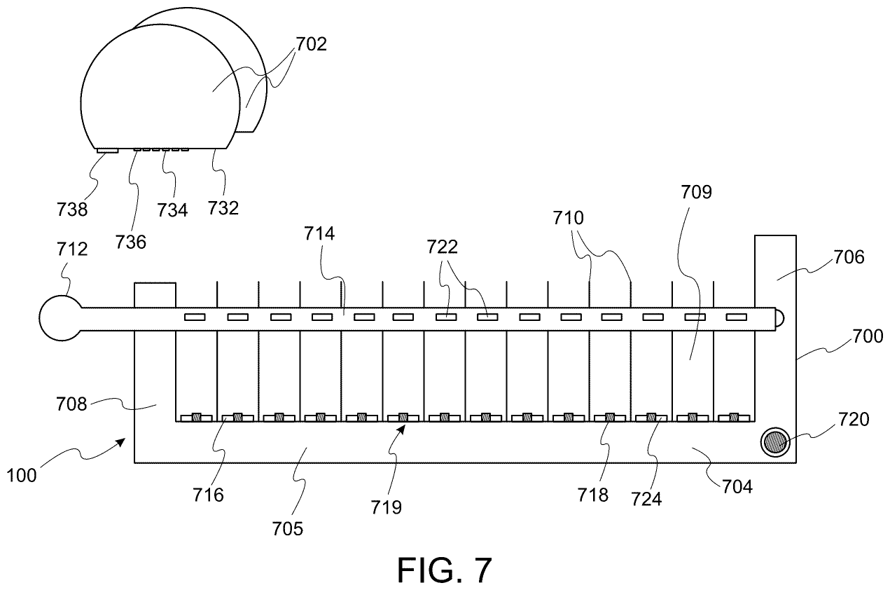

The body 122 may house a lithium ion, solid state, or other type of battery 121 utilized by the cordless lamp 100. The rechargeable battery 104 is configured to fit into the compartment 116 (see FIG. 3). The flat edge 126 allows a user to determine how the rechargeable battery 104 should be aligned within the charger (see FIG. 7). The contacts allow the rechargeable battery 104 to be charged. In another embodiment, the body 122 may be completely circular and the contacts may be positioned along the curved edge of the battery 121. Alternatively, the body 122 may also be rectangularly or square shaped.

The magnets 131 align the rechargeable battery 104 within the charger for properly alignment of the contacts 128 with the contacts, port, or interface of the charger. The curved edge 124 is associated with the curves of the base 102 (see FIG. 1).

FIG. 3 is a pictorial representation of a bottom portion 130 of the cordless lamp 100 in accordance with an illustrative embodiment. Referring to FIGS. 2-3, the bottom portion 130 may include the compartment 116 for receiving the rechargeable battery 104, contacts 132, and a user interface 136.

The contacts 132 may interface with the contacts 128 of the rechargeable battery 104 to power the cordless lamp 100. In one embodiment, the contacts 132 may be spring-loaded to electrically interface with the contacts 132. Alternatively, the contacts 132 may be fixed or the interference fit of the rechargeable battery 104 may properly interface the contacts 132 with the contacts 128.

The magnets 131 may align with the magnets 131 to ensure proper alignment of the contacts 132, 128. The polarity of the magnets 131 may be positioned so that they are attracted toward each other ensuring that the contacts 132, 128 are aligned and stay in contact to power the cordless lamp 100. As previously noted, the contacts 132 may also be aligned with the contacts 128 utilizing an interference fit, rails, tabs, fasteners, and so forth.

The user interface 136 may be utilized to control all or portions of the cordless lamp 100. The user interface 136 may include a power button 138. The power button 138 may be utilized to turn the cordless lamp 100 on and off. The power button 138 may alternatively be used to dim the lamp between settings (e.g., low, medium, bright, etc.), change colors emitted by the LED bulbs, or otherwise reconfigure the lamp 100. The user interface 136 may alternatively include any number of dials, switches, touch interfaces, toggle buttons, or so forth to control the operation of the cordless lamp 100.

In another embodiment, the rechargeable battery 104 may not include an on/off switch. Instead, the cordless lamp 100 may include a user interface which may include an on/off switch, power button, capacitive touch sensor (e.g., touch sensor for turning the cordless lamp 100 on and off), and so forth.

In one embodiment, the compartment 116 may include a recess 140 more easily adding and removing the rechargeable battery 104. When positioned within the cordless lamp 100, the rechargeable battery 104 may be pressed on a side opposite the contacts 132 to rock all or a portion of the rechargeable battery 104 out of the compartment 116 for easy removal. The rechargeable battery 104 may have an indicator 142 showing where the user should press to more easily remove the rechargeable battery 104. For example, the indicator 142 may be a symbol, text, or other markings.

The compartment 116 may be secured to or integrated with the base 102. The rechargeable battery 104 may be secured within the compartment 116 utilizing any number of securing mechanisms. The securing mechanisms may secure or lock the rechargeable battery 104 in place for movement (placement and retrieval), charging, and/or storage. In one embodiment, the securing mechanism may be integrated with the compartment 116 for receiving the rechargeable battery 104. For example, the rechargeable battery 104 may include tabs, ridges, threads, extensions, or structures that interlock with the structure of the securing mechanism to be physically secured. In another embodiment, the securing mechanisms may include tabs, ridges, threads, extensions, or structures that secure the rechargeable battery 104 in place. For example, the rechargeable batteries 104 may be placed in the compartment 116 and then rotated slightly (e.g., clockwise) to lock the rechargeable battery 104 in place. In another embodiment, the compartment 116 may include a magnet for securing a metal plate, tag, or frame integrated with or attached to a top portion of the rechargeable battery 104. The securing mechanisms 131 secure the cordless lamp 100 may be moved or positioned horizontally, vertically, or even up-side-down. The securing mechanisms may also be utilized to secure and store the rechargeable battery 104 in the charger.

The securing mechanisms may also include magnets that interface with the rechargeable battery 104 to lock it in place. In other embodiments, the securing mechanisms may include grippers, an interference fit (e.g., bumpers, narrowing cylinders, gripping materials, etc.), locking arms or plates, or other known locking mechanisms. The compartment 116 and the rechargeable battery 104 may also include indicators to show how to position the rechargeable battery 104 within the compartment 116 (and securing mechanism) to properly lock/secure the rechargeable battery 104 in place (e.g., for movement, charging, storage, updating, etc.). The indicators may include text, markings, symbols, graphics, instructions, drawings, indentations, tabs, lights, or other features that may be easily viewed or felt by a user physically handling the cordless lamp 100 and rechargeable battery 104. For example, the indicators may include logos, emblems, tags, stickers, small indentations, lines, particular decorations, or so forth. The indicators may be an integrated portion of the rechargeable battery 104 or may be added as needed.

In one embodiment, the bottom portion 130 of the lamp may be manufactured or created as a single unit. In another embodiment, the bottom portion 130 of the cordless lamp 100 may be connected to or retrofitted to the cordless lamp 100 as an upgrade to a standard cordless lamp 100. As a result, a standard, default, or dumb lamps may be upgraded with a rechargeable battery 104 and the corresponding components and features as are herein described. Similarly, the rechargeable battery 104 itself may be an upgrade from a traditional battery to a smart battery.

The bottom portion 130, rechargeable battery 104, or a bottom portion of the base 102 may include non-slip materials. Common non-slip materials used on the bottom of the cordless lamp 100 may include rubber, such as silicone or natural rubber, which offers excellent grip and slip resistance. EVA foam (Ethylene Vinyl Acetate) may also be used due to its lightweight, cushioning properties and ability to prevent sliding. Cork is favored not only for its natural, sustainable qualities but also for its rough texture that provides good friction. Neoprene, a synthetic rubber, may be used due to its flexibility and resistance to wear, making it suitable the cordless lamp 100. Additionally, TPR (Thermoplastic Rubber) combines the elasticity of rubber with the durability of plastic, providing reliable grip. In some cases, anti-slip tape or pads may be applied to enhance stability and ensure the cordless lamp 100 stays in place on various surfaces.

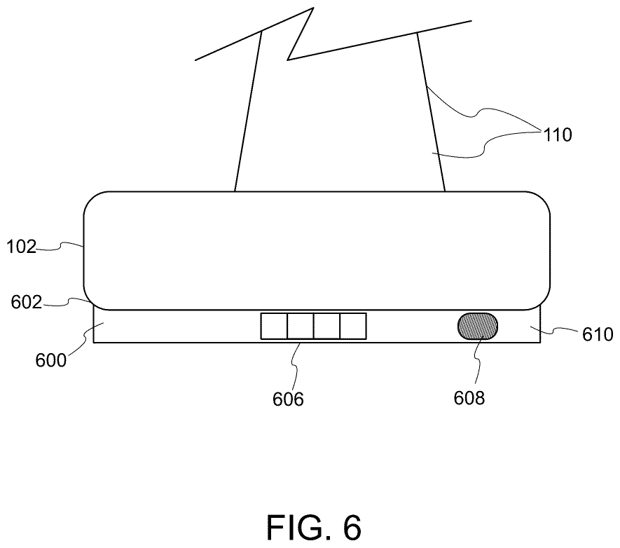

FIG. 4 shows a bottom view of the rechargeable battery 104 within the compartment 116 of the base 102 in accordance with an illustrative embodiment. FIG. 5 shows the rechargeable battery 104 in the process of being removed as a user has pushed on the indicator 142 to make the rechargeable battery 104 accessible. The rechargeable battery 104 may be accessible due to a rocking motion, rotation, pivot, or other motion of the rechargeable battery 104.

FIG. 6 is a pictorial representation of another rechargeable battery 600 in accordance with an illustrative embodiment. The rechargeable battery 600 may be configured to extend slightly beyond a bottom edge 602 of a base. The rechargeable battery 600 may be slightly larger to include more battery material for an extended battery life and increased capacity. In addition, the rechargeable battery 600 may include indicators 606. The indicators 606 may indicate a charge of the rechargeable battery 600 (e.g., 100%, 75%, 50%, 25%) and configuration of a light or other device, such as a cordless lamp (see FIGS. 1-5). For example, the indicators 606 may also indicate a brightness, color configuration, user/table status, or so forth.

In one embodiment, the indicators 606 may be LED lights. In another embodiment, the indicators 606 may be an LED screen or electronic screen that provides written or visual information. The indicators 606 may also double as buttons for receiving input, commands, or control for operating the cordless lamp (or other device). For example, pressing on one of the indicators 606 may turn a cordless lamp on and off, change light intensity, change color, or so forth.

The indicators 606 may also be configured as an infrared interface, optical interface, or antenna for receiving input from a remote control that controls the rechargeable battery 600. As a result, the rechargeable battery 600 may be controlled remotely.

The power switch 608 may be utilized to turn on the cordless lamp. The power switch 608 may also be utilized to control brightness, color, and other components and functions of the cordless lamp/device. The power switch 608 may be a mechanical button or touch sensitive/capacitive button for turning the cordless lamp on and off. The power switch 608 may sit flush with an edge 610 of the rechargeable battery 600 or may protrude for easier access. The power switch 608 may allow the cordless lamp to be turned on or off without picking up

FIG. 7 is a pictorial representation of a charger 700 in accordance with an illustrative embodiment. The charger 700 may be utilized to store and recharge numerous rechargeable batteries 702, such as those shown in FIG. 2. The number of rechargeable batteries 702 that the charger may recharge may vary between 5-30 with some variations charging even more. In one embodiment, the charger 700 may include a frame 704, a back 705, a bottom 706, a top 708, receptacles 709, supports 710, a handle 712, handle edges 714, contacts 716, magnets 718, a power port 720, indicators 722, and electrical components 724.

In one embodiment, the rechargeable batteries 702 may be configured to be quickly and easily placed within the receptacles 709 of the charger 700. The rechargeable batteries 702 include a flat edge 732, contacts 734, magnets 736, and indicator 738. The charger 700 is configured and designed to be stored, held, or positioned horizontally (as shown) or vertically. The back 705 and the bottom 706 are flat to ensure that the charger 700 is stable when positioned horizontally or vertically. The back 705 and bottom 706 may also include non-slip materials to ensure that the charger 700 is stable.

All or portions of the charger 700 including the frame 704 may be molded from a single piece of plastic, metal, or polymer. The frame 704 may also be 3D printed, cast, or assembled from the various components. The magnets 718 of the charger 700 and the magnets 736 of the rechargeable batteries 702 are configured to align each of the rechargeable batteries 702 for charging and storage. For example, the magnets 718 of the charger 700 and the magnets 736 of the rechargeable batteries 702 have opposite polarity so that the magnets 718, 736 are attracted to align the contacts 716 of the charger 700 with the contacts 734 of the rechargeable batteries 702. Aligning and electrically interfacing the charger 700 and the rechargeable batteries 702 is important as the charger 700 is utilized by the user to retrieve or disperse the rechargeable batteries 702 for charging or after charging, respectively.

As utilized herein, the charging interface 719 refers to the electrical connection or coupling between the rechargeable battery 702 and the charger 700 or electronic device for transmitting electrical energy. The charging interface 719 may include physical contact structures such as spring-loaded pins, pogo connectors, or conductive pads, or may alternatively employ an inductive or resonant wireless charging coil. The charging interface 719 may also include alignment guides, insulation barriers, and conductive coatings configured to ensure reliable current flow and minimize arcing or wear during repeated charging cycles.

The supports 710 physically hold the rechargeable batteries 702 (top and bottom) in place while in the charger 700. The handle edges 714 further support the rechargeable batteries 702 (on either side). As a result, the rechargeable batteries 702 are supported on multiple sides for a secure and stable fit within the charger 700.

The user may carry the charger 700 horizontally by holding the back 705 or the handle edges 714 or other portions of the frame 704. The user may carry the charger 700 vertically by holding the handle 712.

The charger 700 may charge numerous rechargeable batteries 702 simultaneously. The power port 720 is the interface for powering the charge to charge the rechargeable batteries 702 of the cordless lamp or electronics. In one embodiment, the charger 700 charges the rechargeable batteries 702 in parallel. The power port 720 may connect to a direct current (DC) power adapter or jack that powers the charger 700 based on a standard electrical connection (e.g. 120 V wall outlet) for various countries. In another embodiment, the bottom 706, top 708 or frame 704 may include one or more large batteries for recharging the rechargeable batteries 702 without using the power port 720. The electrical components 724 including the contacts 716, wires, and power port 720 are routed along or through the frame 704. In one embodiment, the back 705 may be removeable attached to the charger utilizing screws, bolts, tabs, ridges, or so forth for manufacturing, upgrading, maintaining, or servicing the charger 700. In another embodiment, the power port 720 may also represent connectors that may electrically interface with charging components (e.g., pins, connectors, springs, etc.) of a bin, collector, rack on which the charger 700 may be stored or moved for charging the rechargeable batteries 702.

The indicators 722 indicate the charging status of the rechargeable batteries 702. In one embodiment, the indicators 722 may be LED lights. The indicators 722 may indicate whether each of the batteries are empty/red, charging/yellow, and charged/green. In another embodiment, the indicators 722 may include a screen indicating the charge status of all or each of the rechargeable batteries 702.

In another embodiment, the rechargeable batteries 702 may be wirelessly recharged utilizing an inductive charging interface integrated with the frame 704, back 705, or supports 710.

The charger 700 may be positioned or stored in a larger storage receptacle (not shown) for storing multiple chargers in a horizontal or vertical position. For example, the larger storage receptacle may be a bucket or tub that secures each of the chargers. In other embodiments, the charger 700 may include even more storage by accommodating multiple rows of rechargeable batteries 702 that may be positioned next to each other.

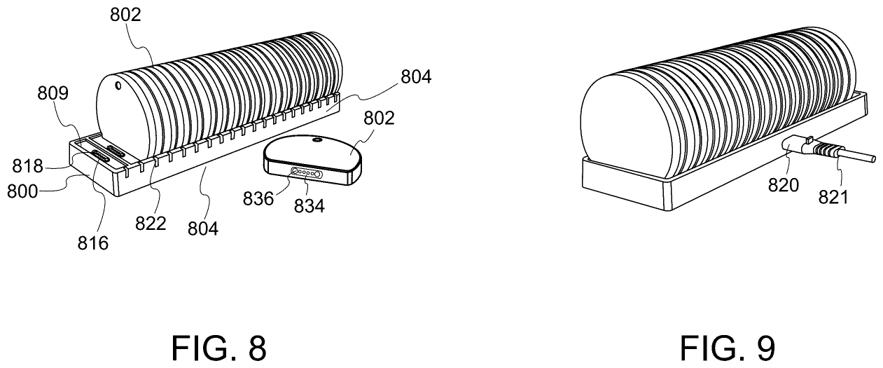

FIG. 8 is a pictorial representation of a charger 800 utilized for horizontal storage in accordance with an illustrative embodiment. The charger 800 may include many or all of the components of the charger 700 of FIG. 7 with some obvious variations. The charger 800 may be utilized to horizontally store rechargeable batteries 802. As shown the charger 800 includes a frame 804. The rechargeable batteries 802 sit within receptacles 809 for charging. The magnets 818 align with magnets 836 of the rechargeable batteries 802 to align contacts 816 of the charger 800 with contacts 834 of the rechargeable batteries 802. The indicators 822 indicate the charging status of each of the rechargeable batteries 802.

FIG. 9 is a pictorial representation of the charger 800 of FIG. 8 shown from another side in accordance with an illustrative embodiment. The power port 820 and a corresponding power adapter 821 may be seen as connected to a standard wall outlet or other power source.

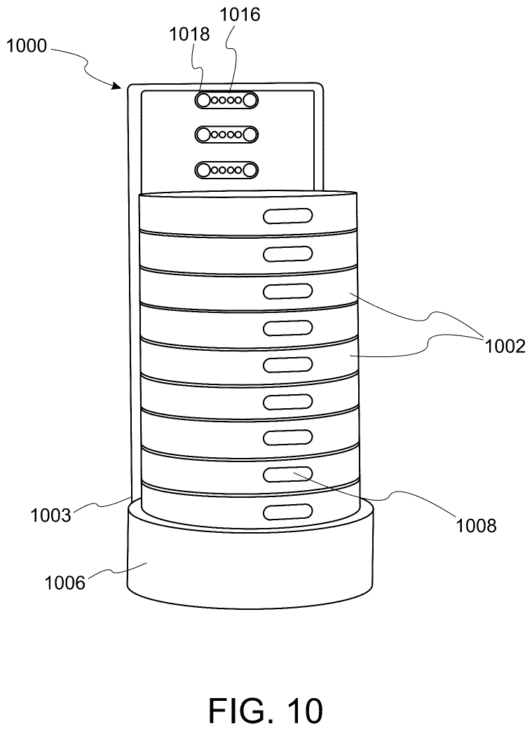

FIG. 10 is a pictorial representation of a charger 1000 utilized for vertical storage in accordance with an illustrative embodiment. The charger 1000 may also include components of the charger 700 of FIG. 7. The charger 1000 is configured to be stored vertically. Rechargeable batteries 1002 may be stacked on top of each other to electrically interface with contacts 1016. Magnets 1018 may ensure proper alignment of the contacts 1016 of the charger with those of the rechargeable batteries 1002. A bottom 1006 (or base) physically supports the rechargeable batteries 1002 including a bottommost battery 1003. As shown, each of the rechargeable batteries 1002 include indicators 1008 indicating the charging status of each rechargeable battery 1002.

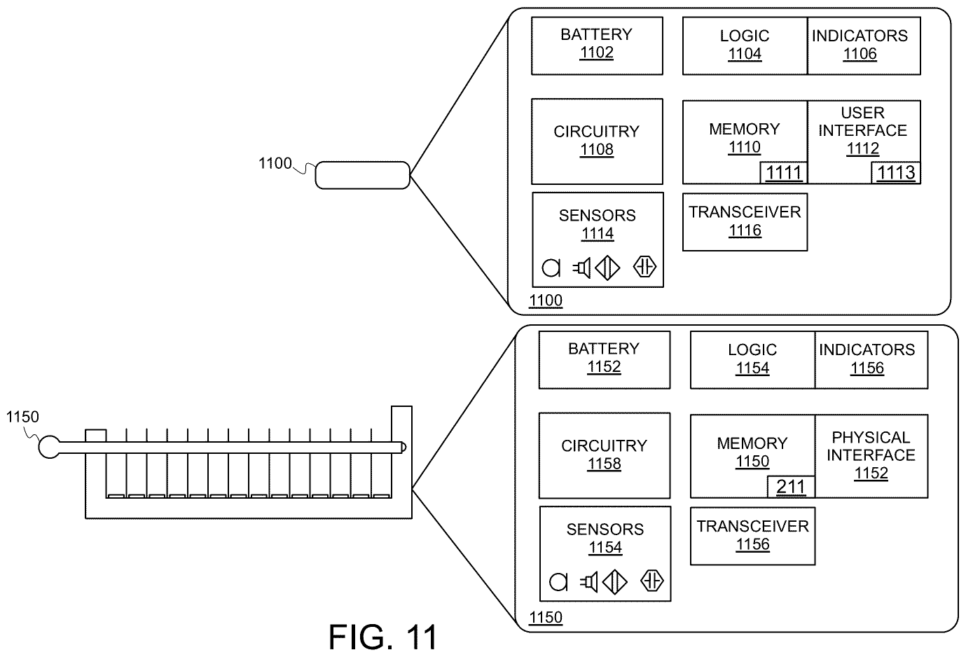

FIG. 11 is a block diagram of a rechargeable battery 1100 and charger 1150 in accordance with an illustrative embodiment. The rechargeable battery 1100 and the charger 1150 may describe, include, and/or correspond to the cordless lamp 100 rechargeable battery 104, rechargeable battery 600, charger 700, charger 800, and included in FIGS. 1-10 and the corresponding detailed description. For example, the cordless lamp 100 of FIG. 1 may include all or portions of the components of the rechargeable battery 1102 and/or charger 1150. In one embodiment, the rechargeable battery 1100 (or the base or frame) may include a battery 1102, logic 1104, indicator 1106, circuitry 1108, memory 1110, settings 1111, user interface 1112, sensors 1114, transceiver 1116.

The rechargeable battery 1100 may communicate with other rechargeable batteries (of the same or different makes/models), cordless lamps/lights, a communications network, and wireless devices (e.g., cell phone, controller, etc.). In one embodiment, the rechargeable battery 1100 may be represented by a single device. The rechargeable battery 1100 may be attached to, integrated with, or connected to an electronic device, such as a cordless lamp, table lamp, or so forth. In other embodiments, the rechargeable battery 1100 may represent a number of networked, interconnected, or communicating devices that communicate and function together to perform the processes and tasks herein described.

As shown, the charger 1150 may also include all or portions of the components of the rechargeable battery as shown in the components 1152-1156. The charger 1150 may be configured to charge the rechargeable battery 1100. The rechargeable battery 1100 may be configured to receive software, configurations, settings, updates, and parameters from the charger 1150.

In one embodiment, the various components of the rechargeable battery 1100 may be hermetically sealed and/or waterproofed utilizing a sealed frame that prevents water from coming in or out. The components may also be chemically coated or sealed to prevent contamination.

The battery 1102 is a power storage device configured to power the rechargeable battery 1100. The battery 1102 may represent lithium-ion (Li-ion) or lithium polymer (Li—Po) batteries, which are favored for their high energy density, light weight, and compact size, making them ideal for the described applications. The battery 1102 may also be a nickel-metal hydride (NiMH) batteries that provides good safety, moderate energy density, and environmental friendliness. The battery 1102 may also represent a solid-state battery because of the higher energy densities, faster charging, and improved safety compared against traditional batteries. The battery 1102 may also represent zinc-air and lithium-titanate batteries because of the long cycle life and stability.

In other embodiments, the battery 1102 may represent a fuel cell, thermal electric generator, signal capture device, piezo electric charger, solar units, thermal power generators, ultra-capacitor, or other existing or developing power generation and storage technologies. The logic 1104 or the settings 1111 preserve the capacity of the battery 1102 by reducing unnecessary utilization of the lamp or electronic device associated with the rechargeable battery 1100 in a full-power mode when there is little or no benefit to the user (e.g., there is no one in the room, there is no noise, the room is entirely dark other than the rechargeable battery 1100, etc.). For example, the sensors 1114 may include motion detection sensors, microphones, or light sensors to determine whether there are users present or the location is use. In one embodiment, the logic 1104 may turn off power provided by the rechargeable battery 1100 as needed.

In one embodiment, the battery 1102 is automatically preserved by the logic 1104, sensors 1114, and other components of the rechargeable battery 1100. In addition, the battery 1102 may use just enough power for the sensors 1114 and/or for the transceiver 1116 to communicate with another cordless lamp, transceiver, charging row, charging base, or so forth. For example, the logic may utilize artificial intelligence to learn when the rechargeable battery 1100 and associated electronic devices should be activated.

In one embodiment, the battery 1102 may be sufficiently large to completely or partially charge a number of wireless devices. For example, the sizes of the rechargeable batteries may vary between 2,000 mAh and 12,000 mAh with greater capacities also expected (e.g., 20,000 mAh). The rechargeable battery 1100 may be regulated by the logic 1104 (which may also include a battery controller, processor, digital logic/analogic circuits, etc.). In other embodiments, the user interface 1112 may include one or more ports, such as USB, mini USB, micro USB, or other connection points. In one embodiment, the battery 1102 may be removable for easily swapping out different batteries for the rechargeable battery 1100 or cordless lamp. In another embodiment, the user interface 1112 may include a retractable cord (e.g., micro USB, lightning, USB-C, etc.) for charging any number of devices. The cord may be temporarily or fixedly attached through one or more USB or other connections as described herein to charge external devices or event to recharge the rechargeable battery 1100. Battery charging may be provided as a complimentary or paid service for users of the cordless lamps. This may be particularly beneficial for users that wish to be able to charge their personal electronic devices in various locations and conditions. For example, a couple that is eating dinner may also charge their smart phones for a night on the town utilizing power provided by the rechargeable battery 1100.

The logic 1104 may represent hardware logic controlling the operations of the rechargeable battery 1100. The logic 1104 may include interconnected electronic components including chips/circuits whether analog or digital logic. In one embodiment, the logic 1104 may represent a processor. The processor is circuitry or logic enabled to control execution of a set of instructions, application, operating system, kernel, modules, or program. The processor may be a microprocessor, digital signal processor, logic unit, application-specific integrated circuits (ASIC), field programmable gate arrays (FPGA), central processing unit (CPU), or other device suitable for controlling an electronic device including one or more hardware and software elements, executing software, instructions, programs, and applications, converting and processing signals and information, and performing other related tasks. The logic 1104 may be a single chip (e.g. ASIC, FPGA, microprocessor, etc.) or motherboard or may be integrated with other computing or communications components.

The logic 1104 may also coordinate choreography and performance across the cordless lamps of the location, venue, event, or activity. The logic 1104 may coordinate control signals that may be sent to the various components of the cordless lamp to implement various settings, configurations, or performances. For example, the light colors generated by the lights may change colors simultaneously, sequentially, in a pattern (e.g., a wave, randomly, in a shape, exterior to interior, etc.), or in any number of ways that automatically determined or specified by a user. In one embodiment, the logic 1104 may control the brightness levels, color, flicker rate, and other performance of the cordless lamps such that the cordless lamps may become part of a show, environment, ambience, or so forth. The logic 1104 may utilize artificial intelligence to learn patterns that are human centric to automatically turn on and off the cordless lamp 100 or to configure performance or functionality. For example, the logic 1104 may control colors emitted by the lamp by time of day.

The indicators 1106 represents one or more light emitting diodes, organic light emitting diodes, polymer light emitting diodes, filaments, lamps, bulbs or so forth. The indicators 1106 may provide information regarding the charge status of the battery 1102, operation of the rechargeable battery (green on, red off, etc.). The indicators 1106 may indicate a charge status through a color, such as red—charge is 25% or less, yellow—charge is 50% or less, blues—charge is 75% or less, and green—charge is 100% or less. The indicators 1106 may also include a screen that provides applicable information regarding charge, emitted light color, flicker rate, brightness, or so forth.

The memory 1110 is a hardware element, device, or recording media configured to store data for subsequent retrieval or access at a later time. The memory 1110 may be static or dynamic memory 1110. The memory 1110 may include a solid-state drive, memory card, random access memory, cache, removable media drive, or other media suitable as storage for data, instructions, and information. In one embodiment, the memory 1110 and the logic 1104 may be integrated. The memory 1110 may use any type of volatile or non-volatile storage techniques and mediums. The memory 1110 may store user preferences, settings 1111, parameters, thresholds, network information, and other applicable information and data.

In one embodiment, the memory 1110 may store information retrieved by the sensors 1114 (see for example FIG. 1). For example, the measurements may include information regarding light and noise levels. The memory 1110 may also store settings 1111. The settings 1111 may be utilized to control the operation and functionality of the rechargeable battery 1100. For example, the settings 1111 may control the color emitted by the light of the cordless lamp, the brightness of the light, the flicker rate of the light, and other applicable information. Additional settings 1111 may include automatic turn/off times or time periods, Wi-Fi networks utilized, authorizations, communications, channels, protocols, passwords, and other applicable settings. The settings 1111 may also store verbal commands that may be given by a user proximate the rechargeable battery 1100.

The rechargeable battery 1100 may include any number of computing and telecommunications components not specifically described herein for purposes of simplicity, such components, devices, or units may include busses, motherboards, circuits, ports, interfaces, cards, converters, adapters, connections, transceivers, displays, antennas, and so forth. The settings 1111 may also control registering and authenticating other rechargeable batteries for synchronization of content, settings, and communications. The settings 1111 may also include one or more names for a network managed, accessed, distributed, or utilized, by the rechargeable battery 1100. For example, the rechargeable battery 1100 may communicate with a router, hub, or wireless device that communicates utilizing one or more Wi-Fi names. In one embodiment, the settings 1111 may store a number of different user profiles associated with a number of administrators or users or the rechargeable battery 1100. The settings 1111 may store hardware identifiers, software identifiers, nicknames, contact lists, or other access information for different cordless lamp or users.

The user interface 1112 is the selection components configured to receive physical input, feedback, selections, commands, or instructions from the user or other devices. The user interface 1112 may include is the buttons, switches, selectors, scroll wheels, touch screen/interfaces, screens, or other components for receiving and outputting information to a user. In one embodiment, the user interface 1112 may include a power button 1113. The power button may also be utilized as an on/off switch, brightness selector, a color dial, and a flicker rate dial for physical adjusting the power status, brightness, color of the light, and flicker rate.

The user interface 1112 may also include a touch screen. The user interface 1112 may also include a user interface for receiving applicable information and selections. For example, the user interface 1112 may be utilized to receive information when a client is ready to make an order, provide payment, ask a question, express a need, indicate a problem/emergency, or provide additional information. For example, the user interface 1112 may receive a selection that activates the indicators 1106, sends a message through the transceiver, or configures a light of the cordless lamp to indicate help or service is needed. In another embodiment, the user interface 1112 may include a transactional interface for receiving automatic payments for food, services, tips, or so forth. The user interface 1112 may also be hermetically sealed allowing physical connections and selections without letting water or other contaminants within the body of the rechargeable battery 1100.

In one embodiment, the user interface 1112 may include the indicators 1106 that shows the battery status or other performance information for the rechargeable battery 1100. In one embodiment, a button, switch, or other component is activated to indicate the battery status or other performance metrics of the rechargeable battery 1100. The indicators 1106 may then be turned off to help maintain the ambience provided by the rechargeable battery 1100.

In one embodiment, the user interface 1112 may also include a port, receptacle, or reader for interfacing with payment devices, such as credit cards, smart cards, debit cards, gift cards, payment chips, bracelets, smart phones, or so forth. For example, the rechargeable battery 1100 may accept payments for goods or services rendered for users proximate that rechargeable battery 1100/table/location. For example, the user interface 1112 may accept payments using a magnetic reader, near field communications chips, EMV, or other applicable standards (e.g., RFID, Google Pay, Apple Pay, Samsung POA, standards based on ISO/IEC 7816 for contact cards, and standards based on ISO/IEC 14443 for contactless cards). The user interface 1112 may also include a microphone for receiving user input verbally or through other sounds. For example, a user may give voice commands to “turn off lamp”, “turn on lamp”, “change light color to blue”, “set light intensity to seven”, “increase flicker rate to thirty hertz”, “set group 3 to medium brightness”, or any number of other controls. Any number of mobile or application program interfaces may be utilized to control the rechargeable battery 1100. The user interface 1112 may be configured to recognize certain voices or commands to prevent unknown users or customers from controlling the electronics.

Although not shown, the rechargeable battery 1100 may include a camera or other image capture device(s). The images may include still and video images that may be retrieved and stored in the memory 1110 or communicated directly to one or more other users. In one embodiment, the camera may be integrated with the rechargeable battery 1100. In another embodiment, the camera may be externally linked utilizing any number of wireless or wired connections, such as a high-definition media interface (HDMI), USB, Bluetooth, or Wi-Fi connections. For example, the rechargeable battery 1100 may be inserted in a base that may capture images for security purposes. The camera may capture content in a week loop to preserve the memory 1110 (e.g., 128 Gb SSD card). The camera may also capture content in response to one or more conditions, such as noise level, time of day, verbal commands, and so forth.

The transceiver 1116 is a component comprising both a transmitter and receiver which may be combined and share common circuitry on a single housing. The transceiver 1116 may communicate utilizing Bluetooth, Wi-Fi, ZigBee, Ant+, near field communications, wireless USB, infrared, optical signals, mobile body area networks, ultra-wideband communications, cellular (e.g., 3G, 4G, 5G, PCS, GSM, etc.) or other suitable radio frequency standards, networks, protocols, or communications. The transceiver 1116 may include a number of different transceivers configured to utilize distinct communications protocols and standards. For example, the transceiver 1116 may be a hybrid transceiver that supports a number of different communications. For example, the transceiver 1116 may communicate utilizing Ethernet, powerline networking, Wi-Fi, Bluetooth, and cellular signals.

The transceiver 1116 may be configured to receive commands, input, and instructions from any number of devices including, but not limited to, commercial controllers, smart controllers (e.g., Amazon Alexa®, Apple® Siri, Google®, smart AI, etc.), wireless devices, and so forth. For example, instructions provided to Amazon Alexa may enable an feature to control the rechargeable battery 1100 individually or as a group.

In one embodiment, the transceiver 1116 may be utilized as a Wi-Fi extender, payment processing device, router, booster, or repeater. As a result, the rechargeable battery 1100 may be utilized to extend a Wi-Fi network for a venue, event, or location. In some embodiments, different cordless lamps may be utilized to extend different networks that may have different users or purposes. The transceiver 1116 may also be utilized to generate a mesh network of cordless lamps. The mesh network may be utilized for commands, updates, instructions, or messages between the cordless lamps or for connecting devices, such as cell phones, tablets, laptops, or so forth utilized by clients or workers associated with a location, event, venue, or so forth.

In another embodiment, the transceiver 1116 may include an inductive charger. The inductive charger may charge cell phones, tablets, watches, or other electronics that are placed under, on, against, or proximate the rechargeable battery 1100. As a result, the rechargeable battery 1100 may recharge other devices increasing the popularity, value, and versatility of the rechargeable battery 1100.

The rechargeable battery 1100 may be controlled individually, as groups, or as an entire set. In one example, a mobile application executed by a cell phone in communication with the rechargeable battery 1100 through the transceiver 1116 may display a map of the available cordless lamps/rechargeable batteries based on placement information (e.g., integrated GPS, beacon, etc.), real-time mapping, wireless triangulation, or other available information to control the rechargeable battery 1100 individually, as a group, or as an entire set.

The rechargeable battery 1100 may also include lamp, light, or electronic hardware and software (not shown, representing the additional hardware and software components and units) that allow the rechargeable battery 1100 to function and interact. Although described with regard to the rechargeable battery 1100, all or a portion of the rechargeable battery 1100 may be applicable to a cordless lamp. In one embodiment, the cordless lamp 0 may be a dumb device that is controlled entirely by the rechargeable battery including all or portions of the logical components.

As previously noted, the rechargeable battery 1100 may be hermetically sealed and waterproof and enclosed in a case, frame, cover, or exterior. Even the electrical components are hermetically sealed to allow the rechargeable battery 1100 to be rinsed, washed off, or submerged. In one embodiment, junctions and electrical components may be chemically and mechanically sealed to provide the waterproof properties of the rechargeable battery 1100.

The sensors 1114, 1154 may determine the temperature of the rechargeable battery 1100 and charger to ensure effective charging. The sensors 1114, 1154 and/or circuitry 1108, may also determine the charge available in the battery 1102, 1152, respectively. The logic 1104, 1154 may utilize charging information and data including past information to perform charging. The sensors 1114, 1154 may also determine the ambient temperature, noise levels, lighting conditions (e.g., for adjusting brightness of a lamp), and other applicable conditions relevant to the rechargeable battery 1110, charger 1150, or environment.

The circuitry 1108 may include a battery management system (BMS), which monitors and controls key parameters such as voltage, current, temperature, and state of charge (SoC) to maintain safe and efficient operation. The BMS incorporates protection circuitry designed to prevent overcharging, over-discharging, and short circuits, which may damage the rechargeable battery 1100 or pose safety risks. The sensors 1114 may include thermal management sensors that detect temperature fluctuations and activate protection mechanisms or regulate the charge/discharge rate to prevent overheating. Additionally, the circuitry 1108 may feature balancing circuits, particularly in multi-cell configurations, to ensure even distribution of charge across all cells, thereby maximizing overall battery life and performance. In some embodiments, the rechargeable battery 1100 may include the transceiver 1116 or communication interfaces (e.g., SMBus or CAN bus) for real-time data exchange with external devices (e.g., cordless lamps, chargers, etc.), enabling advanced monitoring, diagnostics, and control. The components of the rechargeable battery 1100 collectively work to maintain battery health, enhance safety, and extend the lifespan of the battery 1102.

The rechargeable battery may continuously monitor both a state of charge (SoC) and a state of health (SoH) to manage energy delivery and longevity. The SoC represents the remaining available capacity of the battery as a percentage of its rated full charge, determined through coulomb counting, voltage measurement, or impedance estimation. The SoH indicates the overall condition and degradation level of the battery over time, considering factors such as cycle count, internal resistance, and temperature history. These parameters may be calculated and stored by the logic or battery management system (BMS) to optimize charge and discharge behavior, predict maintenance intervals, and communicate performance information to the charger or connected electronic device.

The circuitry 1158 may include wires, traces, transformers, and contacts for charging the rechargeable battery 1100. The circuitry 1158 may include power conversion circuitry, such as a buck or boost converter, to adjust the input voltage to the appropriate level required by the rechargeable battery 100. The circuitry may include an integrated charging controller used to regulate the charging current and voltage according to the battery type, chemistry, and capacity, ensuring that the charging follows an appropriate profile (e.g., constant current/constant voltage for lithium-ion batteries) determine for each of the rechargeable batteries 1100. The circuitry 1158 may include protection circuits, such as over-voltage, over-current, and thermal protection, that may be used to preventing damage to the rechargeable battery 1100 and charger 1150 components. In addition, the charger 1150 may incorporate monitoring circuits that utilize the sensors 1154 to track parameters like battery temperature, voltage, and state of charge (SoC), enabling the controller to adjust the charging rate dynamically. In other embodiments, the circuitry may also include communication interfaces (e.g., I2C, SMBus), such as the transceiver 1156, for real-time data exchange between the charger 1150 and a battery management system (BMS), to enhance precision and safety during the charging process.

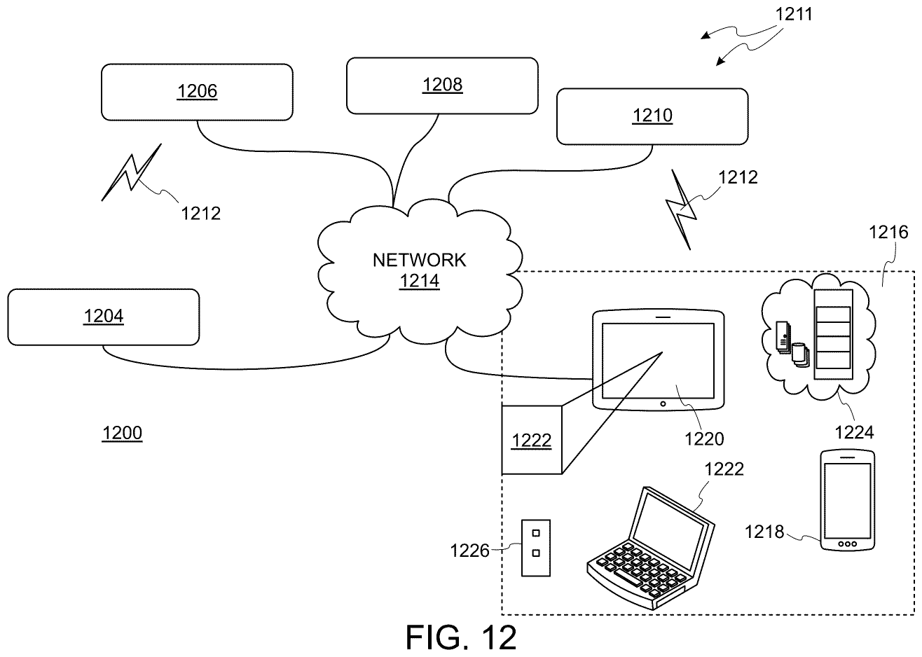

FIG. 12 is a pictorial representation of a rechargeable battery environment 1200 in accordance with an illustrative embodiment. The rechargeable battery environment 1200 may include a rechargeable battery network 1214. The rechargeable batteries 1210 may also be integrated with one cordless lamps or electronics. In one embodiment, the rechargeable battery network 1202 may include rechargeable batteries 1204, 1206, 1208, 1210 (jointly rechargeable batteries 1211) shown for illustrative purposes. The rechargeable batteries 1211 may represent any number of rechargeable batteries (e.g., from one to one thousand). The rechargeable batteries 1211 may communicate directly through a wireless signal 1212 or through one or more networks, such as network 1214.

The rechargeable batteries 1211 may be controlled utilizing any number of devices 1216. In one embodiment, the devices 1216 may include a smart phone 1218, a tablet 1220, a laptop 1222, a cloud system 1224, and a remote control 1226. The devices 1216 may communicate directly with the rechargeable batteries 1211 or through one or more networks, such as the network 1214. The devices 1216 may execute one or more applications for controlling the rechargeable batteries 1211. For example, the applications may execute instructions, programs, scripts, or other sets of instructions to configure the rechargeable batteries 1211 in real-time or when positioned on the charger or so forth. The devices 1216 may also include a remote control 1226. In one embodiment, the remote control is specially configured to control the rechargeable batteries 1211. For example, the remote control 1226 may utilize an infrared signal that may be utilized to individually control the brightness, color, flicker, ambient sensing, and so forth. The devices 1216 may also include a charger with a user interface as are herein described.

The wireless signal 1212 may represent any number of short-range or long-range wireless or infrared signals, such as Bluetooth, Wi-Fi, near-field communications, Zigbee, EnOcean (and the associated hardware/software), or so forth. In one embodiment, the rechargeable batteries 1211 of the rechargeable battery environment 1200 may form a mesh network for sending commands, software updates, settings, messages (e.g., battery status, performance, warnings, etc.), or other additional information. In one embodiment, the rechargeable batteries 1211 may be configured for bilateral communication with the host device for optimizing performance, tracking battery health, and transmitting firmware updates as needed.

In one embodiment, the rechargeable batteries 1211 may be part of established groups so that a single control signal from one of the devices 1216 may control all of the rechargeable batteries 1211 within that group to power on or off the lamps or change performance or settings.

The cloud system 1224 (or other devices 1216) may act as a central control station for the rechargeable batteries 1211. The cloud system 1224 may be controlled locally or remotely. For example, the cloud system 1224 may be utilized by management, administrators, or servers of larger restaurants, events, venues, nightclubs, or other locations. The cloud system 1224 may include any number of networks, servers, databases, data connections, processors, or so forth for controlling the rechargeable batteries 1211. The rechargeable batteries 1211 may also be utilized with the Internet of Things (IoT) functionality, standards, and protocols for messaging, remote sensing, and so forth.

In one embodiment, the cloud system 1224 may control how and when the rechargeable batteries 1211 change settings based on movement, users, temperature, presence of music, voice, and sound, and other ambient conditions. For example, the color of the lamp/rechargeable batteries 1211 may change based on the beat/tempo of the music being played in the flameless candle environment 1200. The rechargeable batteries 1211 may also capture audio to adjust the illumination based on footsteps, conversations, or other sounds or tones that are inaudible. In one embodiment, the lights of the rechargeable batteries may provide a different level

As utilized herein, the term “electronic device” refers broadly to any apparatus or system that operates using electrical energy and may be powered, at least in part, by the rechargeable battery described herein. Examples of electronic devices include cordless lamps, flameless candles, appliances, sensors, communication devices, entertainment equipment, or industrial instruments. The electronic device may be portable or stationary, indoor or outdoor, and may include both “smart” and “non-smart” (legacy) devices that may be upgraded by integrating or coupling the rechargeable battery described in the illustrative embodiments.

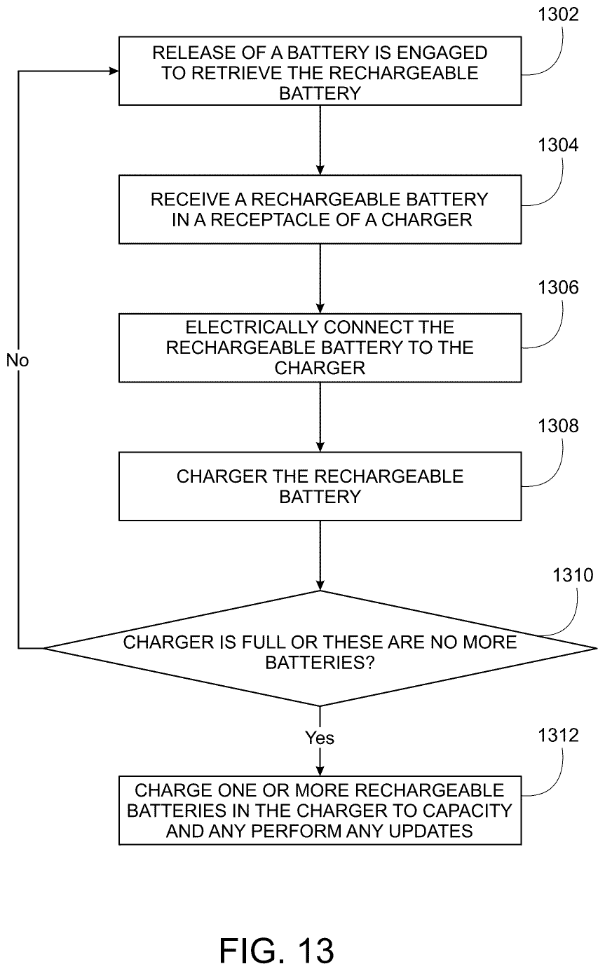

FIG. 13 is a flowchart of a process for utilizing a charger in accordance with an illustrative embodiment. The process of FIG. 13 may be implemented utilizing a charger and rechargeable batteries as shown in FIGS. 1-7 (or other applicable FIGs). The process may begin with a release of a battery being engaged to retrieve the rechargeable battery (step 1302). The release may be an attachment mechanism, toggle point, or release that makes the rechargeable battery accessible to a user, drone, or machine.

Next, the charger receives a rechargeable battery in a receptacle of the charger (step 1304). In one embodiment, the charger may align the rechargeable battery with the frame utilizing magnets that integrated with the charger and/or the rechargeable battery. Each of the charger and rechargeable battery may have magnets or the charger may have magnets, and the rechargeable batteries may have a ferromagnetic material (or vice versa). Other securing mechanisms, such as tabs, interlocks, an interference fit, connectors, or so forth may be utilized to connect the rechargeable battery to the respective receptacle of the charger.

Next, the charger electrically connects the rechargeable battery to the charger (step 1306). The charger may automatically begin charging the battery immediately once connected. In one embodiment, contacts of the charger and rechargeable battery may be aligned to start charging the rechargeable battery. In other embodiments, the charger or individual receptacles/ports may be turned on or off by a user. In one embodiment, the indicators of the charger or rechargeable battery may indicate that the rechargeable battery is charging and/or the charging status (e.g., low, medium, high, percentage charge, error, etc.).

Next, the charger charges the rechargeable battery (step 1308). In one embodiment, the charger may immediately begin charging each rechargeable battery when connected to the charger. In another embodiment, the charger may wait for a designated time period (e.g., 3, 5, 15 minutes) before charging so that the batteries are charged for about the same time under similar conditions.

Next, the charger determines whether all receptacles are used or there are no more batteries (step 1310). In one embodiment, the charger may begin charging once the charger is full. The charger may also determine whether there are more batteries based on a time period, historical charging, or user feedback.

Next, the charger charges the one or more rechargeable batteries and performs any updates (step 1312). The charger applies the appropriate voltage and current to charge the rechargeable battery. In one embodiment, the charger may utilize logic or artificial intelligence to determine the appropriate charging voltage, current, charge level, state of charging, temperature, charging cycles, and so forth. The charge that should be applied to a rechargeable battery is determined by several key factors and conditions, such as battery capacity, battery chemistry, and state of charge. Battery capacity, measured in milliamp-hours (mAh) or amp-hours (Ah), is essential, as it dictates the total charge the battery can hold and thus the appropriate charging current. Most rechargeable batteries require specific charging methods and voltages. The charger ensures these conditions are met. State of charge (SoC), or the current charge level, influences the charging process, as batteries often require a lower current when nearing full charge to prevent overcharging. Temperature is another important factor; excessive heat can damage the battery or reduce efficiency, so some charging systems include thermal management to adjust the charging rate based on temperature. Lastly, charging cycles and battery age can affect how much charge the battery may efficiently accept over time, requiring careful monitoring to prevent degradation or shortened lifespan.

In one embodiment, the rechargeable batteries may have logic that may be updated. For example, the logic may specify how the rechargeable battery is used to maximize battery life. The logic may also include software, instructions, or modules utilized to operate the cordless lamp or other electronic device. The rechargeable batteries may also include payment systems or other tools.

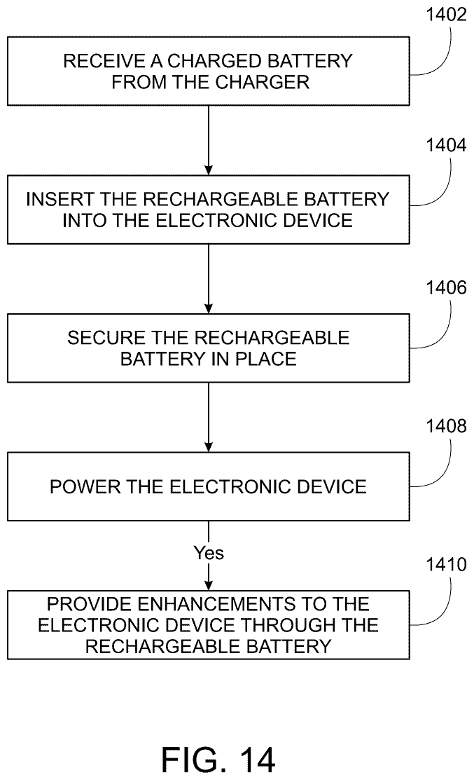

FIG. 14 is a flowchart of a process for utilizing a rechargeable battery in an electronic device in accordance with an illustrative embodiment. The process of FIG. 14 may be implemented utilizing the rechargeable batteries and charger as shown in FIGS. 1-7, or in connection with other embodiments described herein. The process may begin with receiving a charged rechargeable battery from a charger (step 1402). In one embodiment, the rechargeable battery may include indicator lights, display icons, or other electronic signals that confirm the battery is fully charged and ready for use (e.g., see FIG. 11 for internal circuitry 1108 and logic 1104 of the rechargeable battery 1100). The charged battery may be removed from a receptacle of the charger manually by a user or automatically by a mechanical retrieval system.

Next, the rechargeable battery is inserted into an electronic device (step 1404). The rechargeable battery may be aligned with a receiving cavity or compartment of the electronic device. The insertion may occur through a guided slot, bay, or housing designed to correspond to the geometry of the rechargeable battery.

In one embodiment, the battery may include alignment features such as grooves, rails, magnets, or keyed surfaces to ensure proper orientation and electrical contact.

Next, the rechargeable battery is secured in place within the electronic device (step 1406). The securing may be achieved through an attachment mechanism, magnetic retention, snap-fit connectors, or interlocking tabs that prevent unintended disconnection during operation. In some embodiments, the electronic device may confirm that the battery is properly seated by detecting electrical continuity or a mechanical lock signal. The securement mechanism ensures both structural stability and consistent power delivery.

Next, the electronic device is powered utilizing the rechargeable battery (step 1408). Once inserted and secured, the rechargeable battery delivers electrical energy to the internal circuitry of the electronic device. The power may be distributed through a power management circuit that regulates voltage and current according to device specifications. In some embodiments, the rechargeable battery may automatically engage with the electronic device upon insertion, while in other embodiments, a remote control, wireless transmission, and/or manual power button or switch may be used to initiate power flow.

Next, enhancements are provided to the electronic device through the rechargeable battery (step 1410). In one embodiment, the rechargeable battery may include embedded logic, processors, or communication modules that interface with the electronic device to optimize performance. These enhancements may include adaptive power regulation, firmware synchronization, data logging, or wireless communication for system updates. The rechargeable battery may also exchange data with the electronic device, such as reporting state of charge, temperature, or health diagnostics. In another embodiment, the rechargeable battery may include auxiliary functions such as supplemental lighting, energy metering, or environmental sensing.

In some embodiments, the rechargeable battery may enhance device functionality beyond power supply by providing integrated electronic control, payment capability, or environmental interaction features. For example, in a cordless lamp, the rechargeable battery may include microcontrollers configured to adjust brightness, color temperature, or operational timing based on user preferences or environmental conditions. The rechargeable battery may also record operational metrics and communicate with external applications or networks to provide performance feedback, predictive maintenance, or usage analytics.

Thus, FIG. 14 describes an intelligent battery integration process that not only powers an electronic device but also improves device performance, control, and user experience through embedded electronic, communication, and monitoring systems.

The illustrative embodiments are not to be limited to the particular embodiments and examples described herein. In particular, the illustrative embodiments contemplate numerous variations in the type of ways in which embodiments of the invention may be applied to flameless or electronic candles. The various figures, embodiments, steps, and methods may be combined in any order and combination regardless of restrictions (whether naturally or artificially imposed). The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments disclosed with greater particularity.

What is claimed is:

1. A charger for a plurality of batteries, comprising:
a frame providing a support structure, the frame defining a plurality of receptacles for receiving the plurality of batteries;
a plurality of electrical interfaces associated with the plurality of receptacles configured to electronically connect to contacts of the plurality of batteries;
a power system for powering the plurality of electrical interfaces to charge the plurality of batteries, wherein the charger is configured to be stably stored horizontally or vertically.

2. The charger of claim 1, wherein the plurality of batteries are rounded with an edge that is straight, and the wherein the contacts are positioned along the edge.

3. The charger of claim 1, wherein the frame magnetically aligns the plurality of batteries with the plurality of receptacles.

4. The charger of claim 1, wherein the charger is usable and storable horizontally and vertically with the receptacles supporting the plurality of batteries.

5. The charger of claim 1, further comprising:
a handle connecting to the frame for a user to hold the charger while adding or removing the plurality of batteries.

6. The charger of claim 1, further comprising:
an indicator associated with each of the plurality of receptacles including a charging status of each of the plurality of batteries.

7. The charger of claim 1, wherein the indicators utilize colors to indicate the charge status.

8. A method of charging a plurality of batteries for lights, comprising:
receiving a plurality of batteries in a charger;
electrically interfacing battery contacts of each of the plurality of batteries with contacts of the chargers;
indicating a charger status of each of the plurality of batteries, wherein the charger is configured to be stably stored horizontally or vertically.

9. The method of claim 8, further comprising:
storing the charger horizontally or vertically on flat edges of a frame of the charger.

10. The method of claim 8, wherein one or more lights of the charger indicate a charging status of each of the plurality of batteries.

11. The method of claim 8, wherein the plurality of batteries have a flat edge including the battery contacts.

12. The method of claim 8, wherein the charger includes a handle for a user to carry the charger when adding or removing the plurality of batteries.

13. The method of claim 8, wherein the contacts of the charger magnetically interface with the battery contacts of each of the plurality of batteries.

14. The method of claim 8, wherein the plurality of batteries are for cordless lamps.

15. A rechargeable battery, comprising:
a frame for storing internal components;
a battery within the frame for storing a charge for powering at least an electronic device;
an edge within the frame;
contacts integrated within the edge for interfacing the rechargeable battery with a charger and at least the light;
magnets for aligning the contacts with contacts of the light or charger; and
a power button for powering on or off the rechargeable battery.

16. The rechargeable battery of claim 15, wherein the battery is a lithium ion or solid-state battery.

17. The rechargeable battery of claim 15, wherein the light is a cordless lamp.

18. The rechargeable battery of claim 15, further comprising:
one or more indicators indicating a charging status of the battery.

19. The rechargeable battery of claim 15, wherein the one or more indicators utilize colors to indicate the charging status of the battery.

20. The rechargeable battery of claim 15, further comprising:
a user interface for receiving user input and providing information to the user, the power button is a component of the user interface.
